(19) United States
(12) Patent Application Publication
(10) Pub. No.: US 2010/0109550 A1
(43) Pub. Date: May 6, 2010

(54) LED Dimming Techniques Using Spread Spectrum Modulation

(76) Inventors: Muzahid Bin Huda, Los Gatos, CA (US); Ho-Yuan Yu, Saratoga, CA (US)

Correspondence Address: Cheng Intellectual Property Group, 1583 Clarkspur Lane, San Jose, CA, 95129, US

(21) Appl. No.: 12/610,344

(22) Filed: Nov. 1, 2009

Related U.S. Application Data
(60) Provisional application No. 61/198,095, filed on Nov. 3, 2008.

(51) Int. Cl. H05B 37/02

(52) U.S. Cl. 315/287

(57) ABSTRACT

Circuits and methods of LED dimming are disclosed. Frequency modulation using controlled modulation depth generates deterministic sidebands of both the fundamental frequency and its harmonics. Various filters including low-pass, band-pass, high-pass and combinations of those are used to selectively filter the deterministic frequency components generated by the frequency modulation to achieve LED dimming.

### CROSS-REFERENCE TO RELATED APPLICATIONS

This application hereby claims priority from and incorporates by reference the U.S. Provisional Applications with Ser. No. 61/198,095, filed on Nov. 3, 2008, entitled “LED Dimming (or Current Control) Techniques using Spread Spectrum Modulation”, by inventors Muzahid Huda and Ho-Yuan Yu.

This application contains subject matter that may be related to the subject matter in U.S. application Ser. No. 12/575,289, filed on Oct. 7, 2009, entitled “Method and Apparatus for Dynamic Modulation”, by the same inventors, and is herein incorporated by reference.

### BACKGROUND

1. Field of Invention

The present invention relates generally to the field of light emitting diode (LED) driver circuits and dimming of the light emitted by a LED. More specifically, the present invention relates to a method and apparatus for controlling the brightness of light emitted by a LED by applying controlled frequency modulation and filtering energy in frequency components from the LED current spectrum.

2. Description of the Related Art

Light emitting diode (LED) is an electronic light source known for its energy efficiency, long lifetime and small size. It has advanced to a point where LEDs can be used as energy efficient replacement for conventional incandescent or fluorescent light source. Like incandescent and fluorescent light sources, the average brightness (intensity) of a LED's output is controlled by the average current through the device. Unlike incandescent and fluorescent light sources, however, LEDs can be switched on and off almost instantaneously. Conventional ways of controlling the brightness of a LED include controlling the magnitude of LED current and adjusting the duty cycle of a continuous series of current pulses of fixed amplitude flowing through the LED.

Recently, one approach to LED control is described in U.S. Patent Application No. 2008/0111503 A1, by David Van Ess et al. This patent creates random spreading of the frequency spectrum of a continuous current pulse by using a stochastic modulation scheme for controlling optical transducers and allows more effective filtering due to the absence of spectral peaks. However, the frequency components of modulated current are not deterministic and hence the average current amplitude is not deterministic at any point of time. Therefore, it cannot achieve well-controlled LED dimming Furthermore, this type of circuit involves complicated design and circuit components. For the foregoing reasons, there is a need to provide a LED driver circuit without the above problems.

### SUMMARY

It is an objective of the invention to provide a well-controlled LED dimming The technique used in this invention involves precisely controlling the distribution of energy over a range of known frequencies around, below or above the fundamental frequency at which the current through a LED is being switched, and also precisely controlling the distribution of energy over a range of frequencies around, below or above the harmonics of said fundamental frequency. The advantage of using this technique is that a frequency selective circuit can be used to filter out precisely selected individual or groups of frequency components around the fundamental frequency and/or its harmonics. Filtering energy away in such a precise manner from the LED current results in a corresponding, precisely controlled dimming of the LED.

Various embodiments of circuits and methods of controlled dimming of a LED are disclosed. In one embodiment, a spread spectrum modulator is configured to modulate a fixed frequency carrier signal using controlled frequency modulation depths to create a first modulated signal with a first set of deterministic frequency components. A controller, in response to the first modulated signal, is configured to control a current flowing through the light emitting diode to generate a second set of deterministic frequency components. One or more filter responses is used to selectively filter the frequency components from one or both of the first set and the second set of deterministic frequency components to achieve LED dimming The bandwidth of the filter responses is adjustable.

### BRIEF DESCRIPTION OF THE DRAWINGS

These and other features, aspects, and advantages of the present invention will become better understood with regard to the following description, appended claims, and accompanying drawings where:

FIG. 1A to 1C illustrate band-pass filters with various bandwidth and sidebands generated by frequency modulation of the LED current using center spread modulation, in accordance with embodiments of the present invention.

FIG. 1D to 1F illustrate low-pass filters and sidebands generated by frequency modulation of the LED current using center, down and up spread modulation, in accordance with embodiments of the present invention.

FIG. 1G to 1I illustrate high-pass filters and sidebands generated by frequency modulation of the LED current using center, down and up spread modulation, in accordance with embodiments of the present invention.

FIG. 2 conceptually shows a dimming circuit using frequency modulation and utilizing a linear regulator, in accordance with a first embodiment of the present invention.

FIG. 3 conceptually shows a dimming circuit using frequency modulation and utilizing a switching regulator, in accordance with a second embodiment of the present invention.

FIG. 4 conceptually shows a dimming circuit using frequency modulation and a current bypass method, in accordance with a third embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principle defined herein may be applied to other embodiments and applications without departing from the spirit and scope of the present invention. Thus, the present invention is not intended to be limited to the embodiments shown, but is to be accorded the widest scope consistent with the principle and features disclosed herein.

Controlled Sideband Generation with Frequency Modulation

Frequency modulation (FM) of a periodic signal such as a current generates modulation frequency sidebands. These frequency sidebands occur around the fundamental frequency of the modulated signal as well as its harmonics. The amplitude of each modulation sideband, as well as those of the fundamental and its harmonics is a function of the characteristics of the frequency modulation applied to the signal.

The mathematical expression for a simple case of sinusoidal frequency modulation applied to a sinusoidal carrier is given below. But this concept also applies to more complex frequency modulation waveforms. The Modulated waveform is written in the following Bessel series form:

$$\begin{matrix}v = {V}_{C} sin ( wct + δ sin {w}_{m} t ) \\ = J 0 ( δ ) + J 1 ( δ ) sin ( wc + \text{/} - wm ) t + J 2 ( δ ) sin ( wc + \text{/} - 2 wm ) t + J 3 ( δ ) \\ sin ( wc + \text{/} - 3 wm ) r + J 4 ( δ ) sin ( wc + \text{/} - 4 wm ) t + J 5 ( δ ) \\ sin ( wc + \text{/} - 5 wm ) t + J 6 ( δ ) sin ( wc + \text{/} - 6 wm ) t + J 7 ( δ ) \\ sin ( wc + \text{/} - 7 wm ) t + J 8 ( δ ) sin ( wc + \text{/} - 8 wm ) t + …\end{matrix}$$

Where v is the instantaneous amplitude of the modulated waveform, wc is the carrier frequency being modulated and win is the modulation frequency. δ is the modulation depth which is the ratio of the frequency deviation to the modulation frequency (or rate).

The coefficients J0, J1, J2, J3 . . . represent sidebands that are a function of modulation depth δ. Their numerical values of these coefficients for a given value of the modulation depth (δ) up to 8 terms are shown in Table 1 below. However, an infinite number of modulation depths (δ=∞) can be implemented, providing an infinite number of combinations for the carrier and sideband amplitude coefficient J(n), where J(n)=J(0), J(1), J(2) . . . J(∞).

It should be noted that the effect of frequency modulation by a complex modulating frequency on a complex carrier frequency results in additional Bessel terms at harmonics of both the modulating frequency and the carrier frequency.

Table 1: Sideband amplitude for different values of modulation depth δ. An infinite number of modulation depths can be generated, but only ten of them are shown here.

TABLE 1

| | J0(δ) | J1(δ) | J2(δ) | J3(δ) | J4(δ) | J5(δ) | J6(δ) | J7(δ) | J8(δ) | J9(δ) |
|---|---|---|---|---|---|---|---|---|---|---|
| δ = 0 | 1 | | | | | | | | | |
| δ = 1 | 0.77 | 0.44 | 0.11 | 0.02 | | | | | | |
| δ = 1.5 | 0.51 | 0.56 | 0.23 | 0.06 | 0.01 | | | | | |
| δ = 2 | 0.22 | 0.58 | 0.35 | 0.13 | 0.03 | | | | | |
| δ = 3 | −0.26 | 0.34 | 0.49 | 0.31 | 0.13 | 0.04 | 0.01 | | | |
| δ = 4 | −0.40 | −0.07 | 0.36 | 0.43 | 0.28 | 0.13 | 0.05 | 0.02 | | |
| δ = 5 | −0.18 | −0.33 | 0.05 | 0.36 | 0.39 | 0.26 | 0.13 | 0.05 | 0.02 | |
| δ = 6 | 0.15 | −0.28 | −0.24 | 0.11 | 0.36 | 0.36 | 0.25 | 0.13 | 0.06 | 0.02 |
| δ = 7 | 0.30 | 0.00 | −0.30 | −0.17 | 0.16 | 0.35 | 0.34 | 0.23 | 0.13 | 0.06 |
| δ = 8 | 0.17 | 0.23 | −0.11 | −0.29 | −0.10 | 0.19 | 0.34 | 0.32 | 0.22 | 0.13 |

As seen from Table 1, frequency modulation of a current or voltage signal at a known value of modulation depth δ allows sidebands of predictable amplitudes and phases to be generated. In addition, it is also possible to generate a pre-determined number of sidebands and frequency separation. Thus, the waveform of the current into the LED switching at a given frequency when modulated produces sidebands similar to those shown in Table 1 for different values of modulation depth δ. The generated sidebands can be filtered using a low-pass, band-pass or high-pass filter to reduce the energy in the current waveform that is flowing in the LED. The modulation profile, or variation of the frequency over time during each modulation cycle may be linear, non-linear or sinusoidal in shape to achieve brightness dimming of one or more LEDs.

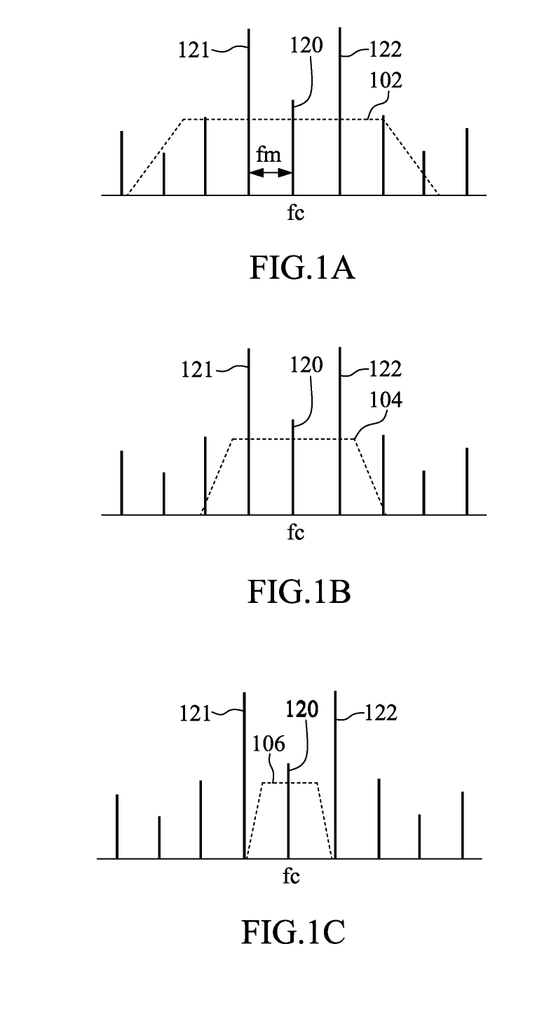

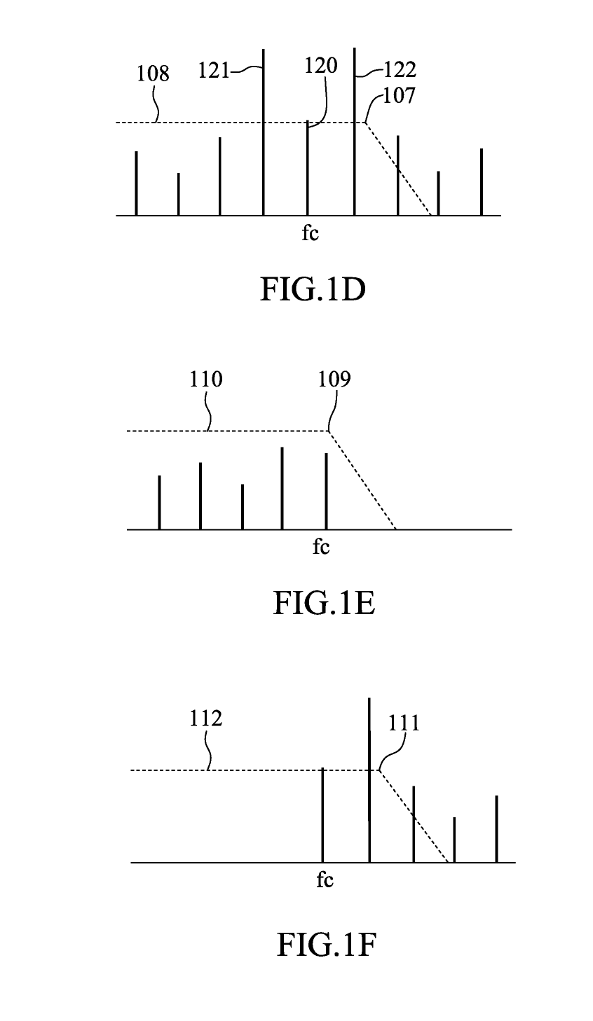

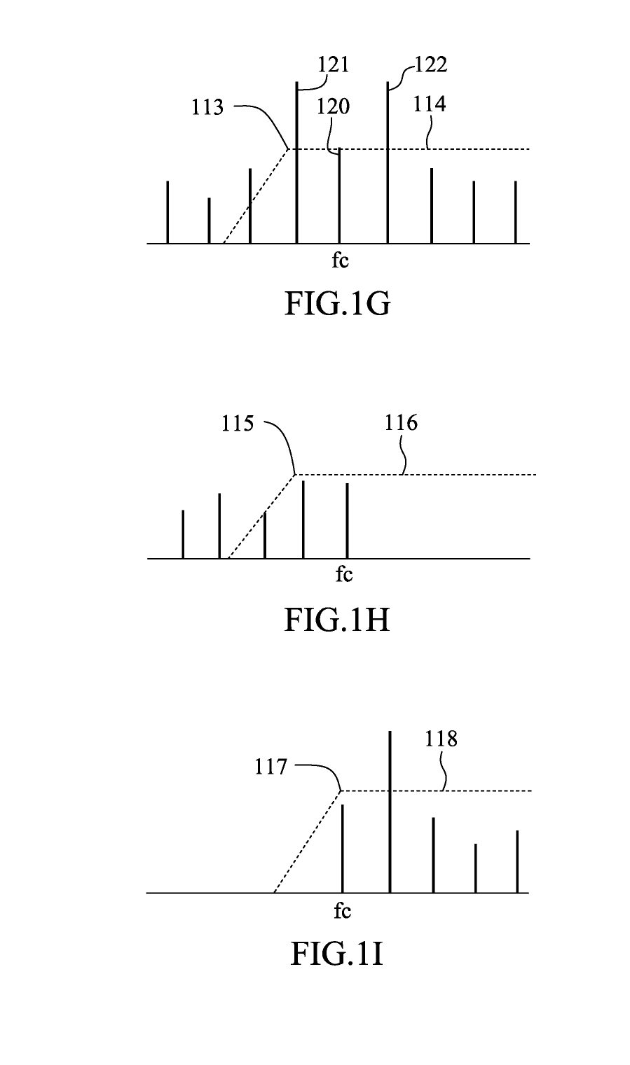

FIGS. 1A through 1I describe the generation of controlled sidebands of both the fundamental frequency (fc), as well as the harmonics, of a periodically varying LED current waveform. As the fundamental frequency of the LED current is frequency modulated, the energy at the fundamental frequency and its harmonics are re-distributed to emerging sidebands. This leads to a reduction in the amplitude of the fundamental frequency and its harmonics, while causing an increase in the amplitudes of the sidebands. Energy re-distribution by controlled frequency modulation is deterministic, and hence the resulting amplitudes of the fundamental, its harmonics and all resulting sidebands can be fully determined and quantified. The requirement for achieving deterministic frequency modulation is that the modulation depth δ is carefully controlled.

This invention discloses the application of center spread, down spread and up spread frequency modulation of the LED current and/or some other parameter that controls or represents the LED current. FIGS. 1A-1D and 1G describe center spread modulation. For center spread frequency modulation, sidebands are generated around the fundamental frequency (fc) 120 and its harmonics (not shown), such as the first lower sideband 121 and the first upper sideband 122. The frequency separation between the fundamental frequency and its corresponding first sidebands 121 and 122 is the modulation rate (fm) as shown in FIG. 1A.

FIGS. 1E and 1H describe down spread modulation. For down spread modulation, sidebands are generated at frequencies below the fundamental frequency (fc) and its harmonics (not shown). This is achieved by frequency modulating the LED current and/or some other parameter that controls or represents the LED current, from a maximum frequency value equal to that of the fundamental frequency to a frequency that is lower than that of the fundamental frequency.

FIGS. 1F and 1I describes up spread modulation. For up spread modulation, sidebands are generated at frequencies above the fundamental frequency (fc) 120 and its harmonics (not shown). This is achieved by frequency modulating the LED current and/or some other parameter that controls or represents the LED current, from a minimum frequency value equal to that of the fundamental frequency to a frequency that is higher than that of the fundamental frequency.

### Energy Filtering (Dimming Filter)

A filter is usually used to pass frequency components within its bandwidth or remove the same frequency components within its bandwidth depending on the connection of the filter to a frequency carrier signal source. When a filter is connected to the frequency carrier signal source in series, the frequency components within the bandwidth of the filter are passed. In this configuration, the filter is called series filter. Conversely, when a filter is connected to the frequency carrier signal source in parallel, the frequency components within the bandwidth of the filter are removed (or diverted). In this configuration, the filter is called bypass filter.

FIGS. 1A-1C illustrates band-pass filters with various bandwidth and sidebands generated by frequency modulation of the LED current using center spread modulation. In FIG. 1A, a wide bandwidth filter 102 is used to remove a relatively large number of frequency components, and hence a relatively large amount of energy from the LED current spectrum, when the band-pass filter is used as a bypass filter (i.e. parallel connection). By adjusting the bandwidth of such a wide band filter function, it is possible to implement high-range (Dark range) dimming levels. In FIG. 1B, a medium bandwidth dimming filter response 104 is used to remove a medium number of frequency components, and hence a medium amount of energy from the LED current spectrum, when the band-pass filter is used as a bypass filter (i.e. parallel connection). By adjusting the bandwidth of such a medium band filter function, it is possible to implement mid-range dimming levels. In FIG. 1C, a narrow bandwidth dimming filter response 106 is used to remove a single, or small number of frequency components, and hence a small amount of energy from the LED current spectrum, when the band-pass filter is used as a bypass filter (i.e. parallel connection). By adjusting the bandwidth of such a narrow band filter function, it is possible to implement low range (Bright range) dimming levels. Conversely, when the band-pass filters 102, 104 and 106 are used as series filter (i.e. serial connection), they may produce opposite filter results to what previously described. In other words, the wide bandwidth filter 102, the medium bandwidth filter 104 and the narrow bandwidth filter 106 can be used to pass a relatively large number, a medium number and a small number of frequency components respectively. The band-pass filters 102, 104 and 106 can be the same band-pass filter that is capable of adjusting its bandwidth or can be different band-pass filters that are used at the same time.

Referring to FIGS. 1D-1F, low-pass dimming filter responses are used to implement the LED dimming circuit. FIG. 1D shows a low-pass dimming filter response 108 with cut-off frequency 107 being used in center spread modulation having fundamental frequency (fc) 120. FIG. 1E shows a low-pass dimming filter response 110 with cut-off frequency 109 being used in down spread modulation in which sidebands are generated at frequencies below the fundamental frequency (fc) and its harmonics (not shown). FIG. 1F shows a low-pass dimming filter response 112 with cut-off frequency 111 being used in up spread modulation in which sidebands are generated at frequencies above the fundamental frequency (fc) and its harmonics (not shown). In these embodiments of the invention, the bandwidth of the low-pass dimming filters can be adjusted from a very small value to a very large value to filter the energy in the LED current and/or some other parameter that controls or represents the LED current. The bandwidth of these dimming filters 108, 110 and 112 can be set from zero to maximum, or even an all pass setting. For example, when the low-pass filters are used as bypass filter (i.e. parallel connection), minimum LED dimming (Brightest LED) is achieved with a zero bandwidth setting. With an all pass setting of the filters, maximum bandwidth (Darkest LED) is achieved. Conversely, when the low-pass filters are used as series filter (i.e. serial connection), maximum LED dimming (Darkest LED) is achieved with a zero bandwidth setting. With an all pass setting of the filters, maximum bandwidth (Brightest LED) is achieved. Varying bandwidth settings between minimum and maximum, or even all pass settings, allow the LED dimming levels to be set at intermediate values between the brightest and darkest desired levels. The low-pass filters 108, 110 and 112 can be the same low-pass filter that is capable of adjusting its bandwidth or can be different low-pass filters that are used at the same time.

Referring to FIGS. 1G-1I, high-pass dimming filter responses are used to filter the energy in the LED current and/or some other parameter that controls or represents the LED current. FIG. 1G shows a high-pass dimming filter response 114 with cut-off frequency 113 being used in center spread modulation having fundamental frequency (fc) 120. FIG. 1H shows a high-pass dimming filter response 116 with cut-off frequency 115 being used in down spread modulation in which sidebands are generated at frequencies below the fundamental frequency (fc) and its harmonics (not shown). FIG. 1I shows a high-pass dimming filter response 118 with cut-off frequency 117 being used in up spread modulation in which sidebands are generated at frequencies above the fundamental frequency (fc) and its harmonics (not shown). In these embodiments of the invention, the bandwidth of the high-pass dimming filters can be adjusted from a very small value to a very large value to filter the energy in the LED current and/or some other parameter that controls or represents the LED current. The bandwidth of these dimming filters 114, 116 and 118 can be set from zero to maximum, or even an all pass setting. For example, when the high-pass filters are used as bypass filter (i.e. parallel connection), minimum LED dimming (Brightest LED) is achieved with a zero bandwidth setting. With an all pass setting of the filters, maximum bandwidth (Darkest LED) is achieved. Conversely, when the high-pass filters are used as series filter (i.e. serial connection), maximum LED dimming (Darkest LED) is achieved with a zero bandwidth setting. With an all pass setting of the filters, maximum bandwidth (Brightest LED) is achieved. Varying bandwidth settings between minimum and maximum, or even all pass settings, allow the LED dimming levels to be set at intermediate values between the brightest and darkest desired levels. The high-pass filters 114, 116 and 118 can be the same high-pass filter that is capable of adjusting its bandwidth or can be different high-pass filters that are used at the same time.

The deterministic values of each of the sidebands in the spectrum of the LED current or other representation of the LED current, that are filtered allows deterministic dimming of one or more LEDs. Any combination of low-pass, band-pass and high-pass filters can be used to implement the dimming filter to filter the amplitudes of the fundamental frequency, its harmonics and any or all frequency modulation sidebands of the LED current, and/or any representation of the LED current to achieve brightness dimming.

### LED Dimming Circuit

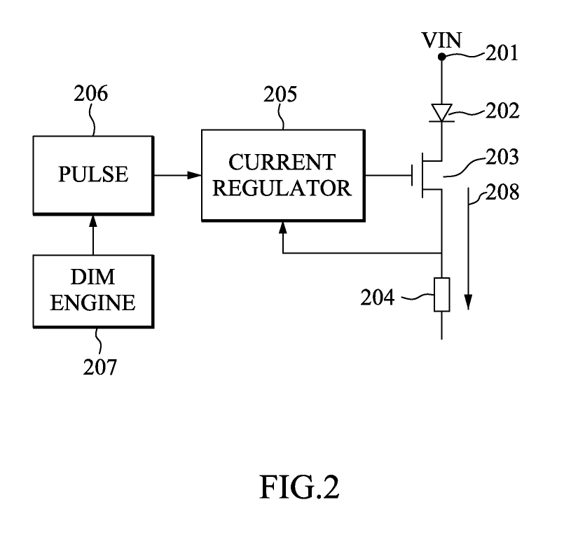

FIG. 2 conceptually shows a dimming circuit using frequency modulation dimming technique together with a linear LED current regulator, in accordance with a first embodiment of the present invention. The figure is for illustrative purpose only and may not show all components which might be known in arts. In FIG. 2, VIN 201 is a current source which generates a periodic current. One end (i.e. anode) of LED(s) 202 is connected to VIN 201 and the other end (i.e. cathode) of LED(s) 202 is connected to the drain of a power device 203 whose gate is regulated by a linear current regulator 205. The current regulator 205 usually includes a gate driver (not shown) which may have an option to be a separate unit. LED(s) 202 can be one LED or many LEDs connected in series or in parallel. Power device 203 can include, but not limited to, a MOSFET, a Bipolar Junction Transistor (BJT) or other device that sources or sinks the LED current. A current sensing resistor 204 is connected between the source of the power device 203 and ground, and also provides a feedback signal to the current regulator 205. A periodic current 208 of constant amplitude flows through LED(s) 202 from VIN 201 to ground.

In this figure, a pulse unit 206 which provides the control input to the current regulator 205 is modulated by a dim engine 207 including a frequency modulation circuit. The pulse unit 206 is a varying signal source that may be a pulse, square wave, sinusoidal signal or any other arbitrary periodic signal of constant frequency. The dim engine 207 comprises a frequency modulation circuit, a circuit for maintaining duty cycle and optional filter(s) described earlier in section “energy filtering”. As is illustrated in FIG. 2, the pulse unit 206 generates control signal to current regulator 205 that works in conjunction with the current sensing resistor 204 to not only regulates the LED current 208 to a constant amplitude, but it also causes the LED current 208 to be periodic as dictated by the input from the pulse unit 206. As a result, dim engine 207 indirectly modulates the frequency of LED current 208 to generate the controlled modulation sidebands described previously which can be filtered by one or more dimming filters to achieve desired dimming. The dimming filters may be in the dim engine 207 or connected directly to LED(s) 202 or both depending on the filtering requirements. Since the frequency components of modulated output signal from the pulse unit 206 and the modulated LED current 208 are substantially the same, it is possible to have more than one dimming filters in different locations where each filter can have slightly different bandwidth to filter different parts of the spectrum. In an alternative embodiment, the dim engine 207 may not have a circuit for duty cycle maintenance and filters can be used to achieve desired dimming.

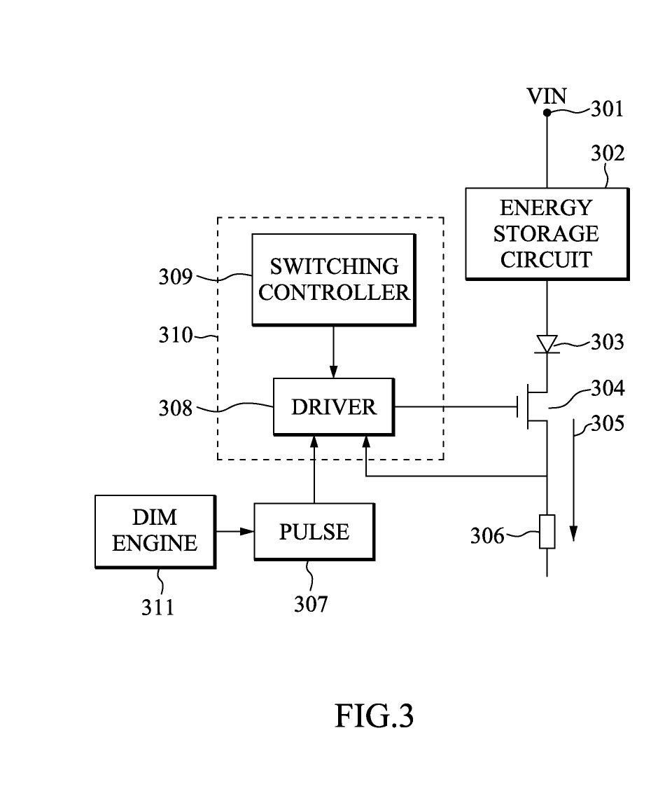

FIG. 3 conceptually shows a dimming circuit using frequency modulation dimming technique and utilizing switching current regulator, in accordance with a second embodiment of the present invention. The figure is for illustrative purpose only and may not show all components which might be known in arts. In FIG. 3, VIN 301 is a current source which generates a periodic current. An energy storage element 302, such as an inductor or flyback transformer that is used in common switching regulators, is connected between VIN 301 and one end (i.e. anode) of LED(s) 303. LED(s) 303 can be one LED or many LEDs connected in series or in parallel. The other end (i.e. cathode) of LED(s) 303 is connected to the drain of a power device 304 whose gate is regulated by a switching current regulator 310 comprising a switching controller 309 and a gate driver 308. The switching controller 309 and the gate driver 308 may be integrated as an unit even though they are shown separately in this figure. In alternative embodiments, the switching current regulator 310 may be PWM or other types of switch mode LED current regulators including soft and hard switching regulator. The power device 304 can include, but not limited to, a MOSFET, a Bipolar Junction Transistor (BJT) or other device that sources or sinks the LED current. A current sensing resistor 306 is connected between the source of the power device 304 and ground, and also provides a feedback signal to the switching current regulator 310. A periodic current 305 of constant amplitude flows through LED(s) 303 from VIN 301 to ground.

In this figure, a pulse unit 307 which provides the control input to the current regulator 310 is modulated by a dim engine 311 including a frequency modulation circuit. The pulse unit 307 is a varying signal source that may be a pulse, square wave, sinusoidal signal or any other arbitrary periodic signal of constant frequency. Similar to the dim engine of FIG. 2, the dim engine 311 of FIG. 3 comprises a frequency modulation circuit, a circuit for maintaining duty cycle and optional filter(s) described earlier in section “energy filtering”. As is illustrated in FIG. 3, the pulse unit 307 generates control signal to current regulator 310 that works in conjunction with the current sensing resistor 306 to not only regulates the LED current 305 to a constant amplitude, but it also causes the LED current 305 to be periodic as dictated by the input from the pulse unit 307. As a result, dim engine 311 indirectly modulates the frequency of LED current 305 to generate the controlled modulation sidebands described previously which can be filtered by one or more dimming filters to achieve desired dimming. The dimming filters may be in the dim engine 311 or connected directly to LED(s) 303 or both depending on the filtering requirements. Since the frequency components of modulated output signal from the pulse unit 307 and the modulated LED current 305 are substantially the same, it is possible to have more than one dimming filters in different locations where each filter can have slightly different bandwidth to filter different parts of the spectrum. In an alternative embodiment, the dim engine 311 may not have a circuit for duty cycle maintenance and filters can be used to achieve desired dimming.

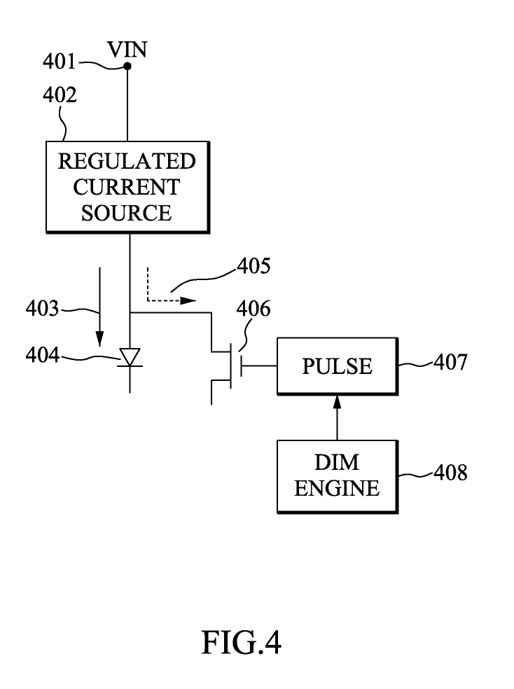

FIG. 4 conceptually shows a dimming circuit using frequency modulation and current bypass method, in accordance with a third embodiment of the present invention. The figure is for illustrative purpose only and may not show all components which might be known in arts. In FIG. 4, a current source VIN 401 is connected to a regulated current source 402 which can include either a linear type current regulator or switching type current regulator. When the regulated current source 402 contains a linear type regulator, the regulated current source 402 is equivalent to the combined circuit components of linear regulator 205, power device 203 and current sensing resistor 204 of FIG. 2. On the other hand, when the regulated current source 402 contains a switching type regulator, the regulated current source 402 is equivalent to the combined circuit components of switching regulator 310, power device 304 and current sensing resistor 306 of FIG. 3. The output of the regulated current source 402 goes to both LED(s) 404 and another power device (or switch) 406 which is used to divert the LED current 403.

In this figure, a pulse unit 407 that generates control signal to control the gate of the power device 406 is modulated by a dim engine 408 including a frequency modulation circuit. As a result, the LED current 405 is diverted by the power device 406 and the pulse unit 407 at a periodic rate. The shape of the diverted current 405 can be a pulse, square wave, sinusoidal signal or any other arbitrary periodic signal of constant frequency. Similarly, the dim engine 408 comprises a frequency modulation circuit, a circuit for maintaining duty cycle and optional filter(s) described earlier in section “energy filtering”. The dim engine 408, through pulse unit 407 and power device 406, modulates the frequency of the LED current 403 to generate controlled modulation sidebands described previously which can be filtered by one or more dimming filters to achieve desired dimming The dimming filters may be in the dim engine 408 or connected directly to LED(s) 404 or both depending on the filtering requirements. In an alternative embodiment, the dim engine 408 may not have a circuit for duty cycle maintenance and filters can be used to achieve desired dimming.

The foregoing descriptions of embodiments of the present invention have been presented for purposes of illustration and description only. They are not intended to be exhaustive or to limit the present invention to the form disclosed. Accordingly, many modifications and variations will be apparent to practitioners skilled in the art. Additionally, the above disclosure is not intended to limit the present invention.

What is claimed is:

1. A method for controlling the intensity of light emitted by at least one light emitting diode, comprising:
modulating a fixed frequency carrier signal using controlled frequency modulation depths to created a first modulated signal with a first set of deterministic frequency components;
applying said first modulated signal to control a current flowing through said light emitting diode to generate a second set of deterministic frequency components; and
applying one or more filter responses to selectively filter one or both of said first set and said second set of deterministic frequency components, wherein bandwidth of said filter responses is adjustable.

2. The method of claim 1, further comprising:
providing a mechanism for maintaining the duty cycle of said fixed frequency carrier signal when modulating.

3. The method of claim 1, wherein modulating a fixed frequency carrier signal includes an up spread modulation, a down spread modulation or a center spread modulation.

4. The method of claim 1, wherein applying said first modulated signal includes controllably diverting said current flowing through said light emitting diode to reduce the intensity of light emitted by said light emitting diode.

5. The method of claim 1, wherein said filter responses include one or more items selected from the group consisting of low-pass filter, band-pass filter and high-pass filter.

6. The method of claim 1, wherein said frequency components are fundamental frequency, its corresponding harmonics and sidebands of both said fundamental frequency and said harmonics.

7. The method of claim 1, wherein controlling said current includes a current regulator and a power device coupled to said light emitting diode.

8. The method of claim 7, wherein said current regulator is a linear current regulator.

9. The method of claim 7, wherein said current regulator is a switching current regulator.

10. An apparatus that controls the intensity of light emitted by at least one light emitting diode, comprising:
a spread spectrum modulator configured to modulate a fixed frequency carrier signal using controlled frequency modulation depths to created a first modulated signal with a first set of deterministic frequency components;
a controller, in response to said first modulated signal, configured to control a current flowing through said light emitting diode to generate a second set of deterministic frequency components; and
one or more filter responses being used to selectively filter one or both of said first set and said second set of deterministic frequency components, wherein bandwidth of said filter responses is adjustable.

11. The apparatus of claim 10, further comprising:
a control mechanism configured to maintain the duty cycle of said fixed frequency carrier signal when modulating.

12. The apparatus of claim 10, wherein said spread spectrum modulator is configured to perform an up spread modulation, a down spread modulation or a center spread modulation.

13. The apparatus of claim 10, wherein said controller can be configured to controllably divert current from said current flowing through said light emitting diode to reduce the intensity of light emitted by said light emitting diode.

14. The apparatus of claim 10, wherein said filter responses include one or more items selected from the group consisting of low-pass filter, band-pass filter and high-pass filter.

15. The apparatus of claim 10, said frequency components are fundamental frequency, its corresponding harmonics and sidebands of both said fundamental frequency and said harmonics.

16. The apparatus of claim 10, wherein said controller includes a current regulator and a power device coupled to said light emitting diode.

17. The apparatus of claim 16, wherein said current regulator is a linear current regulator.

18. The apparatus of claim 16, wherein said current regulator is a switching current regulator.
